(19) United States
(12) Patent Application Publication
(10) Pub. No.: US 2003/0208349 A1
(43) Pub. Date: Nov. 6, 2003

(54) Minimizing event scheduling overhead in VHDL simulation

(75) Inventor: Andy Huang, San Jose, CA (US)

Correspondence Address: ANDY HUANG, 2880 ZANKER ROAD, SUITE 203, SAN JOSE, CA, 95134, US

(73) Assignees: Mr. Andy Huang, San Jose, CA; ACAD, Corp., San Jose, CA

(21) Appl. No.: 10/063,627

(22) Filed: May 3, 2002

(51) Int. Cl. G06G 7/62

(52) U.S. Cl. 703/17

(57) ABSTRACT

A method for minimizing event scheduling overhead in VHDL simulation were proposed, and the speed-up of the VHDL simulation time can be obtained. It consists of the two ideas. The first idea excludes any events that do not have any effects on VHDL simulation. The second idea is grouping multiple homogeneous events, and treating them as a single event to reduce the burden of scheduling in the simulation. These idea were applied separately as well as in a combined way.

### CROSS REFERENCE TO RELATED APPLICATIONS

U.S. Pat. No. 5,384,710 January, 1995 Lam et al. 364/489. Other References IEEE Std 1076-1993, IEEE Standard VHDL Language Reference Manual, New Youk, N.Y.: The Institute of Electrical and Electronics Engineers, Inc., 1993.

### BACKGROUND OF INVENTION

The present invention relates to computer-aided design (CAD) tools for simulating integrated circuit described in VHDL.

VHDL has been widely used to describing and designing the ASIC or system, since IEEE standardized at 1987. There also have been many efforts to speed up the design process using VHDL, because the design with it becomes increase exponentially. Lots of VLSI designs are over thousand of millions of gates to accomplish the recent electronic mobile appliance and multi-media equipments. The most time-consuming job in the VLSI design process is VHDL simulation.

There are many contributing efforts to speed-up the VHDL simulation: the time to compile VHDL source file, the time to elaborate the compiled data to fix initial values and to make the net-list of the whole design, and the time to simulate beginning from the elaborated data. The simulation time of the VLSI design mostly depends on how to execute the behavioral part of the original VHDL source code and how to optimize the simulation kernel. To reduce the simulation time and enlarge the capacity of the VLSI simulation, event-driven technique were devised and adopted at 1990s. Simply speaking, the event is defined as a signal activity that there is a change of the value of the signal while simulating the circuit. The event based simulation outperformed conventional simulation technique, called interpretive simulation technique, at least ten times faster in simulation speed. In the event based VHDL simulation, the major job of the simulation kernel is handling the events, the numbers of the events were huge and increase exponentially according to the size of the design. Therefore, how to reduce overhead of the events is one of the major issue for speeding up digital simulation such as VHDL simulation, logic simulation, etc

### BRIEF DESCRIPTION OF DRAWINGS

FIG. 1 is a modified flow of VHDL simulation employing a preferred embodiment of the present invention

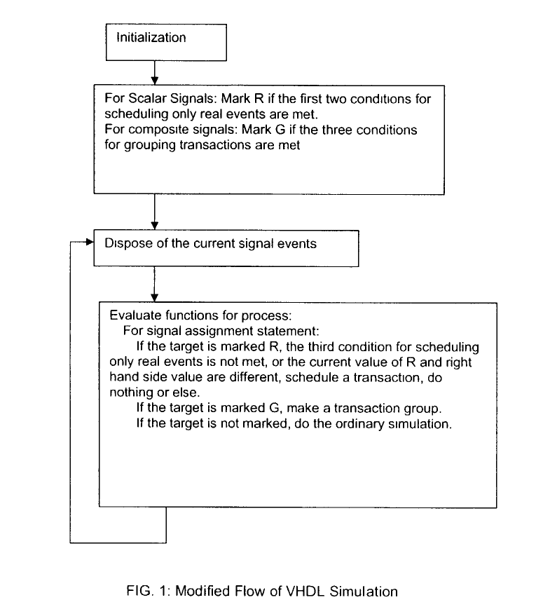

### DETAILED DESCRIPTION

Scheduling Real Events Only (by Removing Non-Real Events)

In VHDL simulation, new transactions (transaction is a possible future event consisted of time and value pair) are produced at every signal assignment regardless of the difference between the value to be assigned and the current value of the signal. If the two values are the same, the produced transactions are useless in most cases, one of the non-real events. It is one of the characteristics of VHDL that degrades the simulation speed. For the signal that meets the following conditions, we can obtain correct results even if we generate new transactions only when the two values are different.

Condition 1: The signal that is from a single source of the functional block or a gate.

Condition 2: The signal that does not contain one of the attributes among “ACTIVE, “LAST_ACTIVE, “TRANSACTION, and “QUIET attribute.

Condition 3: The signal that does not have transactions to be evaluated at the current time.

In VHDL, the effective value of the signal is computed from all the driving values. If a signal has multiple drivers, which violates the first condition, we do not know whether the current driving value will make an event of the signal. The second condition is necessary because the values of attributes can be changed by any transaction regardless of whether the transaction will make a real event or non-real event. If transactions are already scheduled for the signal which violates the third condition, comparing two values is not enough to decide whether the new transaction is a real event or not. A computationally expensive model should be applied to make such decision.

Grouping Transactions

For composite signals such as arrays and records, the time taken by scheduling transactions can be further reduced. When a value is assigned to a composite signal a new transaction is produced for each element of the signal. If the following conditions are met for a composite signal, the results of simulation are unaltered even if the transactions of its elements for an assignment are maintained in an abstracted form.

Condition 1: The composite signal has a single driver.

Condition 2: The composite signal is always assigned a value as a whole.

Condition 3: The composite signal that does not has one of the attributes among the “LAST_EVENT, “LAST_ACTIVE”, and “LAST_VALUE attribute.

The first two conditions insure that the transactions for the elements are always produced at the same time. To see if the second condition is met, another static analysis is required for the driving process. If a composite signal is assigned a value in a process, any other statements in the process should not assign a value to a slice of the signal. For composite signals that meet the above conditions, a single object called “transaction group” is enough to represent the effect of the assignment and can be dealt as a single transaction by the simulation kernel.

To support the transaction group, the data structure for the transaction should be modified to contain a flag and a value for each element. The flag is used to indicate whether the transaction for the element is canceled by another transaction according to the VHDL delay mode. For the compatibility with other signals, the flags for a transaction group are represented by an integer or a similar representation. If an integer is used for the flags, the transaction group can have 32 elements. If the composite signal has more than 32 elements, the transaction group is divided into multiple transaction groups and each of which has less than of equal to 32 elements.

As the data structure for transaction is modified, the execution codes for the attributes in the third condition should be generated differently. However, we do not know at the time of code generation for compiled simulation whether such attributes will be used for a composite signal. Even though such attributes are not used for a signal in the current design unit, they may be used for the signal in the other design units. A simple method to resolve this problem is maintaining transactions ordinarily for such a signal. That is why the third condition should be included.

Combined Method

For signals that meet both sets of conditions, one for scheduling real event and one for grouping transactions, the latter is applied first. Usually more transactions are reduced when the latter is applied because it reduces all the transaction for an assignment to a composite signal to only on transaction group. The former is applied for the rest of the signals.

### APPLICATION EXAMPLE

Consider the following VHDL description.

process

begin

A<=B and C;--A, B, and C are BIT type.

D(7 downto 0)<=E(15 downto 8);

F(3 downto 0)<=“0000”;

if A=1 then

F(0)<=“1”;

G(3 downto 0)<=“0000”;

else

G(3 downto 0)<=“1111”;

end if;

end process;

According to the VHDL standard, sensitization of the above process always makes a transaction for signal A. However, the simulator checks to see if signal A meets the first two conditions to schedule as an real event at the elaboration or initialization phase. During the simulation, the evaluation function for the above process statement checks dynamically the third condition and compares the current value of A with the value to be scheduled (right hand side value: B and C). If the checking and comparison are failed during simulation, the ordinary transaction is scheduled. One transaction group is used to schedule eight transactions for signal D(7 downto 0). Transactions for signal F(3 downto 0), however, cannot be grouped, because F(0) may have another transaction in another assignment statement, which violates the second condition for grouping transaction. On the contrary, G(3 downto 0) have no problem for grouping transaction. This signal is assigned a value in the both assignments as a whole.

1. A method to reduce overhead of event scheduling for VHDL simulation, in a computer system, comprise: static analysis of the VHDL input descriptions and the characteristics of VHDL signals before executing the simulation to remove that do not affect values of the signals value, i.e. remove non-real events. To remove the non-real events and schedule real events for simulating the VHDL, the first two conditions were applied, which are described in the preferred embodiment; dynamic check of the third condition for scheduling real events while removing the non-real events, by comparing the current value of the signal and the right hand sided value—previous value of the signal—as described in the preferred embodiment.

2. The method as recited in claim 1, wherein said VHDL is a hardware description language including VHDL as a subcomponent.
